(19) United States
(12) Patent Application Publication
(10) Pub. No.: US 2014/0333104 A1
(43) Pub. Date: Nov. 13, 2014

(54) MOMS CAR SEAT

(71) Applicant: Maxwell Opoku Agyemang, South Miami, FL (US)

(72) Inventor: Maxwell Opoku Agyemang, South Miami, FL (US)

(21) Appl. No.: 13/893,282

(22) Filed: May 13, 2013

(51) Int. Cl. B60N 2/24; B60R 22/00

(52) U.S. Cl. CPC B60N 2/24; B60R 22/00
USPC 297/256.15

(57) ABSTRACT

The pregnant passenger and fetus have many intrinsic combinations of risk factors making them vulnerable to pregnancy loss and possible death during vehicle accidents. In most cases of fetal loss in motor vehicle accidents the cause was placenta abruption. It takes very little changes in force for the placental tissues to separate. Seat belt in the pelvis area is a suspicious culprit even though it will take highly complex computer and experimental models to substantiate this. The fact of traditional seat belts in any close proximity of the pregnancy leaves us to question if it is paradoxically not the cause such high restraining pressures on the pregnancy.

Hence, the MOMS SEAT is based on the concept of upper body safety restraining in transport of pregnant women, instead of current abdominal and pelvis restraining which can cause pregnancy loss.

### BRIEF SUMMARY OF INVENTION

MOMS CAR SEAT is a car seat with an integral design for rigid safety for both the pregnant mother and the fetus during vehicular transport. During pregnancy this seat will be mounted onto car manufactured seats, and can be detached when needed. The MOMS CAR SEAT depicts a comfortable seat. It has two straps that adjustably restrain bilateral shoulders with a third adjustable strap that crosses the chest just above the nipple line connecting the former two straps. The uniqueness: there is a preventative measure without added danger of restraining pressures anywhere near the pregnancy. These provide a comfortable seating for the mother and safe protection for both her and the fetus. The belt system on the MOMS CAR SEAT is designed to safely restrain up to 500 lb of pregnant woman. The seat has an attaching mechanism that makes it securely fastened to vehicle manufactured seats. Altogether, the MOMS CAR SEAT will be able to overcome a force of 3000-10000 N during vehicle accidents in retaining the mother. Sizes: MOMS CAR SEAT is an adult-sized seat the concept of which is for safety, and also manufactured to accommodate pregnant adult female of any body mass index.

### DESCRIPTION OF VIEWS/FIGURES/INVENTION

FIG. 1: A frontal view of MOMS CAR SEAT. Number (1) labeled references to the back of the seat. Labeling (6) is the bottom of the seat to accommodate the gluteus or bottom of the mother. The back (1) and the bottom (6) are designed to accommodate adult sized pregnant woman.

FIG. 1 also depicts labeling (2) which references to two restraining straps for the shoulders. The two straps (2) are firmly attached to the seats back (1). Both (2) straps separately extend to respective sides of the seat with buckles at the respective ends. The buckles are shown in another view. The strength of the strap mechanism is to hold up to 500 lb of pregnant female.

FIG. 1 also shows labeling (3) and (4) which references to the solid retaining mechanism crossing the chest slightly above the nipple line to abduct the straps (2)

FIG. 2: Shows a side view of MOMS CAR SEAT securely fastened into the vehicles manufactured seat. Labeling (7) depicts the buckling device at the end of strap (2) which makes either strap adjustable, yet squarely solid when in place. (5) is the other strap that comes from the side of the seat to insert into buckle (7). This can be adjusted to any length.

Labeling (7) and (8) is the car manufacturer's seat belt that threads through the MOMS SEAT to retain it in place.

FIG. 3: Depicts strap (2), already described in FIG. 1, inserting securely into the back of the seat (moms seat). Also shown is labeling (10) referencing to a fortified opening (slot) in MOMS CAR SEAT that allows attachment of car manufacturer's seat belt.

FIG. 4: This is the front page view. The view embodies the entire concept of the invention. It shows an adult pregnant female strapped comfortably in place in the MOMS SEAT. As seen from the view, she is retained safely in the upper body without any belts crossing protruding and vulnerable abdomen and the pelvis area.

FIG. 5: Shows the MOMS CAR SEAT secured in place in the car manufacturer's seat. Labeling (11) is the manufacturer's seat belt retaining the seat in place. The way it works is to first secure the MOMS CAR SEAT into any seat of the car using the manufacturer's seat belt. Then proceed to sit in it inserting the shoulders into the shoulder straps. Next: Click the chest buckle into place and then proceed to adjust the shoulder straps on the side if needed.

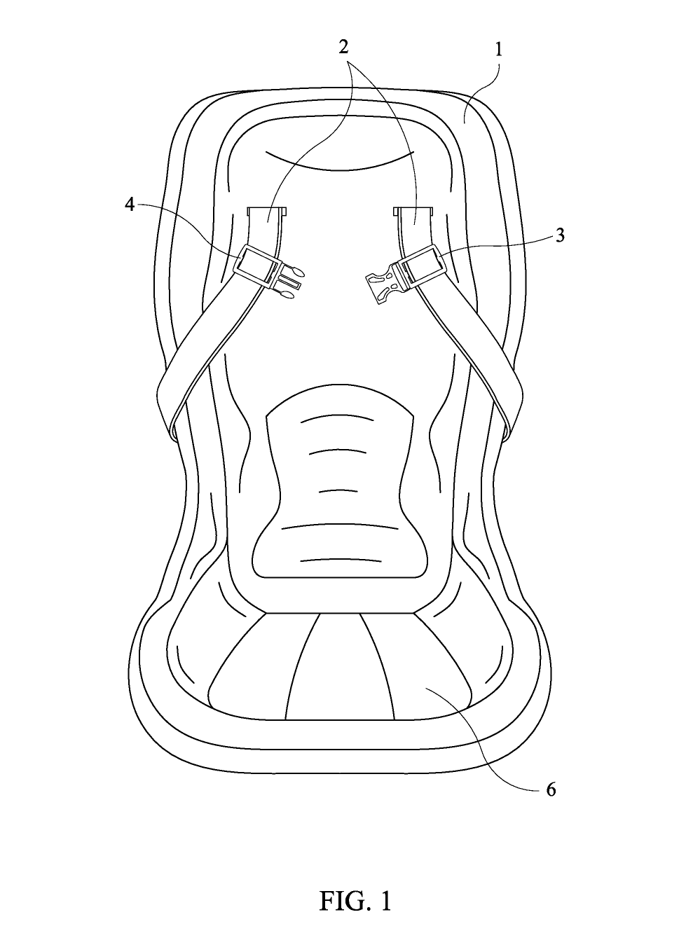

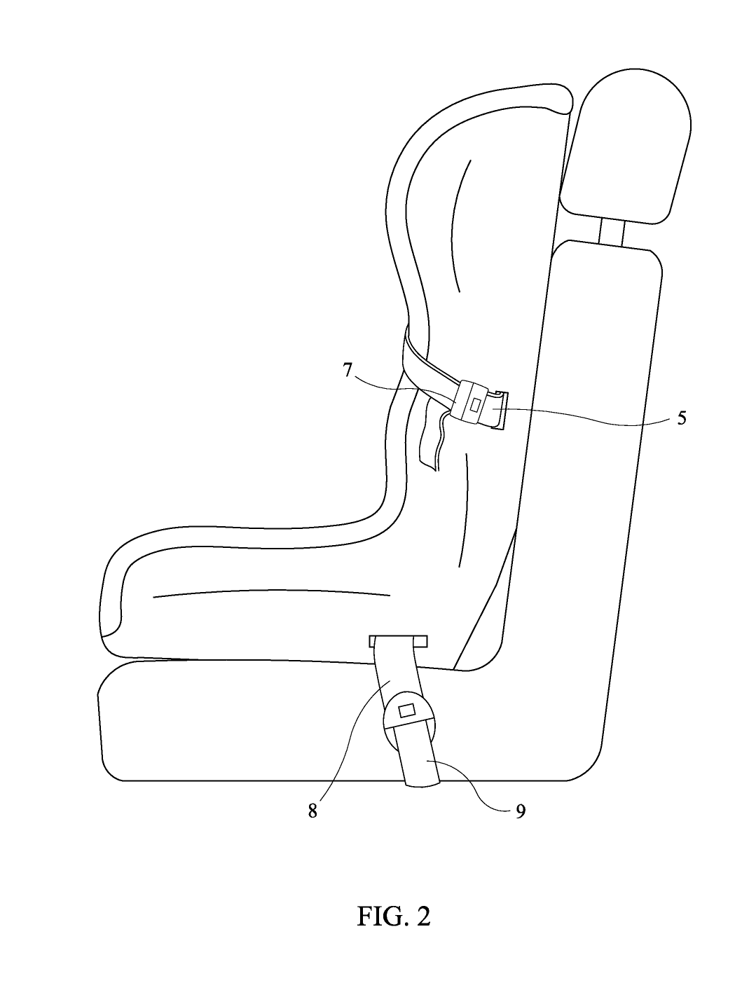

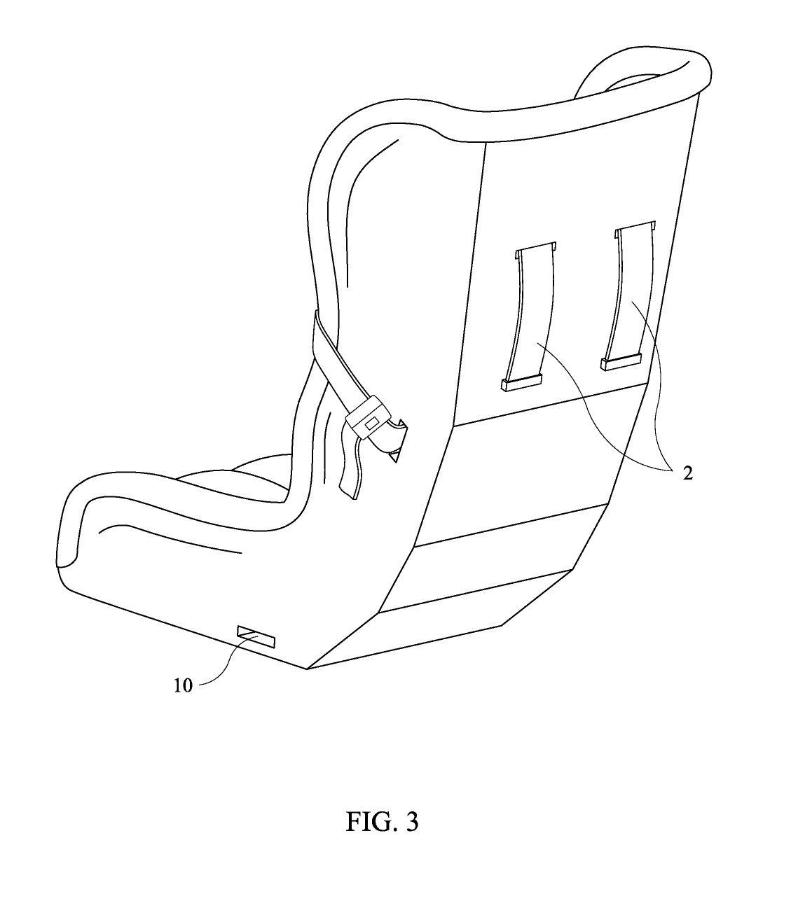

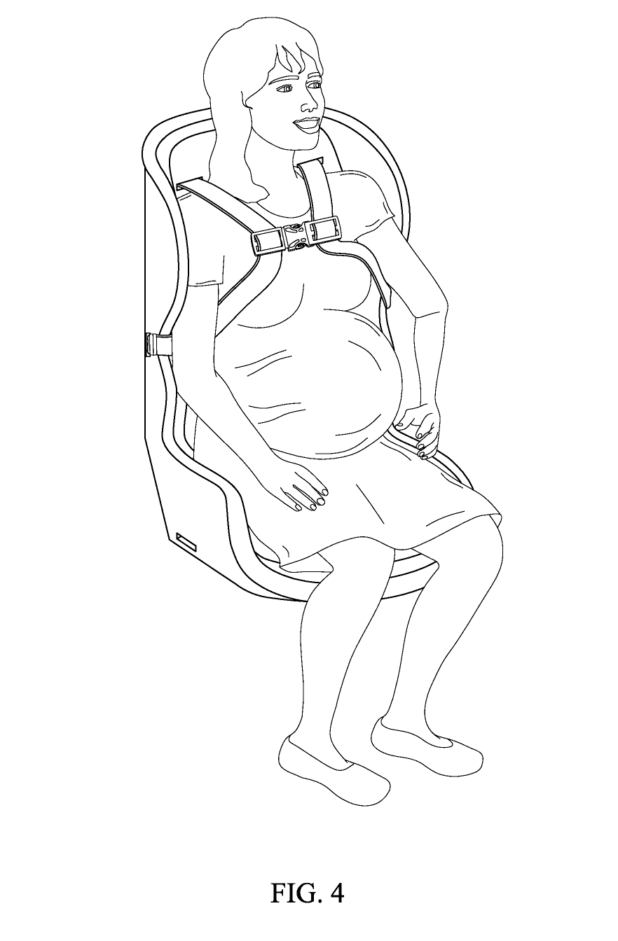

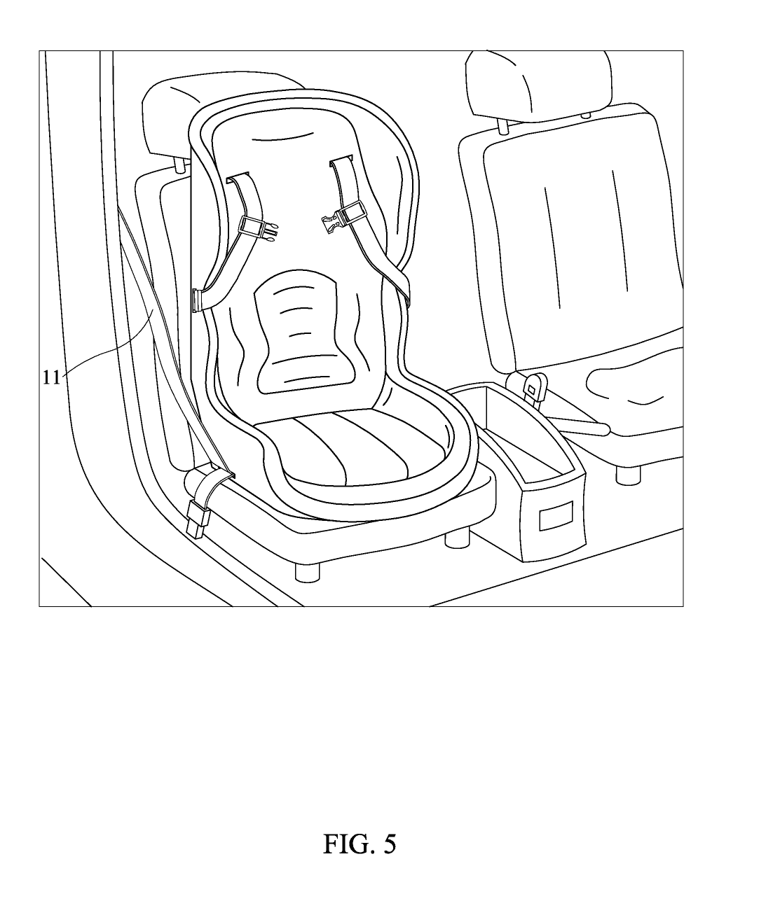

1. Traditional car seat belts restraining the abdominal and pelvic regions of pregnant mothers can cause pregnancy loss hence MOMS CAR SEAT as depicted and described in this invention as shown in FIGS. 1, 2, 3, 4, and 5 to avert such deadly occurrences.

2. In, pregnancy, claiming the concept of upper body safety restraining in vehicular transport of pregnant women, instead of the current abdominal and pelvic restraining which can cause pregnancy loss
